(19) United States
(12) Patent Application Publication
(10) Pub. No.: US 2019/0285142 A1
(43) Pub. Date: Sep. 19, 2019

(54) SET FOR THE MANUFACTURE OF EPICYCLIC GEAR TRAINS

(71) Applicant: Bühler Motor GmbH, Nürnberg (DE)

(72) Inventors: Daniel Kirchgeßner, Rimpar (DE); Katherine Bee, Nürnberg (DE); Jürgen Strüber, Nürnberg (DE); Sebastian Krippner, Langenzenn (DE); Julia Tiller, Nürnberg (DE); Reiner Hettych, Nürnberg (DE)

(73) Assignee: Bühler Motor GmbH, Nürnberg (DE)

(21) Appl. No.: 16/353,299

(22) Filed: Mar. 14, 2019

(30) Foreign Application Priority Data
Mar. 16, 2018 (DE) 10 2018 106 146.3

(51) Int. Cl. F16H 1/28; F16H 57/08

(52) U.S. Cl. CPC F16H 1/28; F16H 57/082

(57) ABSTRACT

A set for the manufacture of epicyclic gear trains with different gear reductions, including at least one planet carrier, which features at least two first holes arranged on a first circular line, and at least two second holes arranged on a second circular line, and at least one first cover ring for a first gear reduction and at least one second cover ring for a second gear reduction, each of which features at least two bearing holes for receiving bearing pins of planet gears, wherein the first cover ring features at least two connecting pins for connecting to the first holes of the planet carrier, and the second cover ring features at least two connecting pins for connecting to the second holes of the planet carrier. In addition, the invention relates to a gear assembly that is formed from such a set.

### CROSS-REFERENCE TO RELATED APPLICATIONS

The present patent application claims priority from German Application No. DE 10 2018 106 146.3, filed on Mar. 16, 2018, which is incorporated herein by reference in its entirety.

### BACKGROUND OF THE INVENTION

### (1) Field of the Invention

The invention relates to a set for the manufacture of epicyclic gear trains and to a gear assembly consisting of such a set.

### (2) Description of Related Art Including Information Disclosed Under 37 CFR 1.97 and 1.98

Epicyclic gear trains, such as are known from DE 10 2013 105 527 A1, usually have a planet carrier, which can receive a plurality of planet gears. For this purpose, the planet carrier features holes, which are arranged on a circular line. The holes serve to accommodate bearing pins, which serve as axles of planet gears.

The gear reduction of such an epicyclic gear train is determined, among other things, by the diameter or the number of teeth of the planet gears. In order to be able to use as many identical components as possible for epicyclic gear trains with different gear reductions, it is therefore known to equip the planet carrier with different holes, which are arranged on different circular lines of the planet carrier. For example, a group of holes can accommodate first planet gears for a first gear reduction and an additional group of holes can accommodate second planet gears for a second gear reduction.

The planet carrier in accordance with DE 10 2013 105 527 A1 is designed in this manner and therefore serves as a standard component for epicyclic gear trains with different gear reductions.

However, previously known solutions, in which planet carriers are provided with different holes on different circular lines, lead to the risk of incorrect assembly. In particular, there is the risk that planet gears for a second gear reduction are mounted in holes of the planet carrier that are provided for the planet gears of a first gear reduction. Due to the high variety of components, this risk is increased in particular by the use of bolts, which are arranged in the holes and then accommodate planet gears. The incorrectly assembled gear trains then cannot produce the desired effect.

### BRIEF SUMMARY OF THE INVENTION

Against this backdrop, the task of the present invention is to specify a set for the manufacture of epicyclic gear trains with different gear reductions, wherein individual components of the set are designed in such a manner that incorrect assembly is largely avoided. It is also the task of the invention to show a gear assembly that is composed of such a set.

Thus, the invention is based on the idea of specifying a set for the manufacture of epicyclic gear trains with different gear reductions, wherein the set preferably comprises the following components:

a. at least one planet carrier that features at least two first holes arranged on a first circular line, and at least two second holes arranged on a second circular line, wherein the first circular line and the second circular line feature different radii;

b. at least one first cover ring for a first gear reduction and at least one second cover ring for a second gear reduction, each of which features at least two bearing holes for receiving bearing pins of planet gears, wherein the first cover ring features at least two connecting pins for connecting to the first holes of the planet carrier, and the second cover ring features at least two connecting pins for connecting to the second holes of the planet carrier, and

c. at least two first planet gears for a first gear reduction and at least two second planet gears for a second gear reduction, wherein each of the first planet gears and the second planet gears features two bearing pins, which can be mounted in the first or second holes of the planet carrier on the one side and the bearing holes of the cover ring on the other side.

The invention avoids the problem of incorrect assembly, which is known from the prior art, by assigning a cover ring for a specific gear reduction to each of the planet gears for the same gear reduction. The cover ring features connecting pins that occupy the holes in the planet carrier that are not used by the bearing pins of the planet gears.

In specific terms, the set for the manufacture of an epicyclic gear train with a first gear reduction may comprise a first cover ring and at least two first planet gears, wherein the connecting pins of the first cover ring engage in first holes of the planet carrier, so that the bearing pins of the planet gears can be inserted into the second holes of the planet carrier.

At least two second planet gears are combined with a second cover ring to manufacture an epicyclic gear train with a second gear reduction, wherein the second cover ring features connecting pins inserted into the second holes of the planet carrier. By contrast, the second planet gears are mounted in the first holes of the planet carrier.

Since the first and second holes of the planet carrier are arranged on different circular lines, the first and second cover rings differ significantly from each other. This is because the connecting pins of the first cover ring are arranged on a different circular line than the connecting pins of the second cover ring. This ensures that the first cover ring can only be connected to the first holes of the planet carrier, while the second cover ring can only be connected to the second holes of the planet carrier.

Even if the planet gears are incorrectly inserted into the holes of the planet carrier, this becomes apparent at the latest when the cover ring is fitted. This prevents an incorrect assembly of the entire gear assembly.

A further improvement can be achieved by the planet gears initially being connected to the associated cover ring during the assembly process. Since the cover ring features connecting pins, the planet gears can only be inserted into the bearing holes arranged between the connecting pins. This initially avoids an incorrect arrangement of the planet gears in the planet carrier.

According to a preferred embodiment, the set according to the invention provides that the first holes of the planet carrier feature a different diameter than the second holes of the planet carrier. The different diameters of the first and second holes also ensure that the bearing pins of the planet gears are not inadvertently incorrectly connected to the planet carrier.

In this respect, it is preferably provided that the bearing pins of the first planet gears feature a diameter that corresponds to the diameter of the second holes of the planet carrier. Alternatively or additionally, the bearing pins of the second planet carrier can feature a diameter that corresponds to the diameter of the first holes of the planet carrier. The bearing pins are preferably formed in one piece with the planet gears or formed in one piece on the planet gears.

In this case, the diameters of the bearing pins and the diameters of the holes are dimensioned in such a manner that the planet gears can be mounted in the holes of the planet carrier with a clearance fit. In particular, the diameters of the bearing pins and the holes are matched to each other such that the bearing pins can rotate in the holes.

In specific terms, it is advantageously provided that the first planet gears can only be combined with the first holes of the planet carrier, whereas the second planet gears can only be expediently combined with the second holes of the planet carrier. In this manner, an incorrect assembly can also be avoided in a different assembly sequence, in which the planet gears are first connected to the planet carrier.

In order to be able to realize different gear reductions, it is preferable provided that the first planet gears feature a larger outer diameter, in particular a larger number of teeth, than the second planet gears. In order to avoid an incorrect assembly of the second planet gears, which may in particular feature a smaller outer diameter than the first planet gears, it can be provided that the bearing pins of the first planet gears feature a smaller outer diameter than the bearing pins of the second planet gears.

In an advantageous embodiment of the invention, it is provided that each of the connecting pins of the second cover ring features a distance to each other that is smaller than a diameter of the first planet gears. In this manner, it is ensured that the second cover ring, which is to be combined with the second planet gears to manufacture an epicyclic gear train, cannot be combined with the first planet gears. This also prevents an incorrect assembly of the epicyclic gear train.

In order to be able to mount the planet gears in the holes of the planet carrier and the bearing holes of the cover ring, it is advantageously provided that the connecting pins and bearing holes of the first cover ring and of the second cover ring are arranged on different circular lines. In this case, the diameter of the circular lines preferably corresponds to the diameter of the circular lines of the planet carriers assigned to them. This ensures that free bearing holes of the first or second cover ring are aligned with free holes of the planet carrier so that a first or second planet gear can be accommodated therein in a rotatably mounted manner.

In particular, the connecting pins of the first cover ring can be arranged on a circular line, the diameter of which corresponds to the diameter of the first circular line of the planet carrier. The connecting pins of the second cover ring can be arranged on a circular line, the diameter of which corresponds to the diameter of the second circular line of the planet carrier. This provides additional safety during assembly, as the connecting pins of the first cover ring can therefore only be connected to the first holes of the planet carrier, whereas the connecting pins of the second cover ring can only be connected to the second holes of the planet carrier.

Each of the connecting pins of the cover rings preferably features one body section and one head section. In particular, it is provided that the head section features smaller circumferential dimensions than the body section. For example, the head section may feature a smaller outer diameter than the body section. The head section is preferably used for connecting to a hole in the planet carrier. In particular, the head section can be press-connected to a hole of a planet carrier.

In this respect, it is preferred if the body section features a contact surface for the planet carrier, wherein, in preferred embodiments, the contact surface is arranged at least in sections perpendicularly to a longitudinal axis of the connecting pin. In this respect, the contact surface forms a stop for the planet carrier. Thus, the body section of the connecting pin can serve as a spacer between the planet carrier and the cover ring.

The body section preferably features at least one outer dimension that is larger than the diameter of the first or second holes of the planet carrier. In other words, it is provided that the body section is designed such that it cannot engage in the holes in the planet carrier.

The head section preferably can be press-connected to the first or second holes of the planet carrier. For this purpose, it may in particular be provided that the head section features a polygonal, in particular regularly polygonal, cross-sectional shape. Such a cross-sectional shape is particularly suitable for a press connection, which features a high degree of stability.

In additional preferred embodiments, it is provided that the planet carrier features at least one flattened side on its circumference. This makes it easy to clamp the planet carrier into an assembly tool.

Further, it may be provided that each of the first cover ring and the second cover ring features flattened sides. Preferably, the flattened sides of the cover rings align with the flattened sides of the planet carrier in the assembled state. The flattened sides of the cover rings, in conjunction with the flattened sides of the planet carriers, allow the planet carrier to be correctly aligned with the respective cover ring. This can be done, for example, by a machine that detects the flattened sides of the cover rings and positions them correctly relatively to each other. Preferably, the planet carrier is made of a metal and/or a plastic. The cover ring can be made of plastic.

An additional aspect of the invention relates to a gear assembly that consists of a set described above. The gear assembly preferably features a planet carrier, a first cover ring or a second cover ring and at least two first planet gears or at least two second planet gears.

### BRIEF DESCRIPTION OF THE SEVERAL VIEWS OF THE DRAWINGS

In the following, the invention is explained in more detail on the basis of an exemplary embodiment and by reference to the enclosed, schematic drawings. Therein are shown:

FIG. 1 shows an exploded view of an epicyclic gear train with a first gear reduction, which is manufactured from a set according to an exemplary embodiment according to the invention;

FIG. 2 shows a perspective view of the assembled epicyclic gear train in accordance with FIG. 1;

FIG. 3 shows a sectional view of the epicyclic gear train in accordance with FIG. 1;

FIG. 4 shows an exploded view of an epicyclic gear train with a second gear reduction, which is manufactured from a set according to an exemplary embodiment according to the invention;

FIG. 5 shows a perspective view of the assembled epicyclic gear train in accordance with FIG. 4;

FIG. 6 shows a sectional view of the epicyclic gear train in accordance with FIG. 4;

FIG. 7 shows a front view of an epicyclic gear train with a second gear reduction, which is manufactured from a set according to an exemplary embodiment according to the invention;

FIG. 8 shows a longitudinal view through the epicyclic gear train in accordance with FIG. 7;

FIG. 9 shows a front view of an epicyclic gear train with a first gear reduction, which is manufactured from a set according to an exemplary embodiment according to the invention;

FIG. 10 shows a longitudinal view through the epicyclic gear train in accordance with FIG. 9; and

FIG. 11 shows a longitudinal view of a motor gear combination with a gear assembly made from a set according to an exemplary embodiment according to the invention.

### DETAILED DESCRIPTION OF THE INVENTION

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

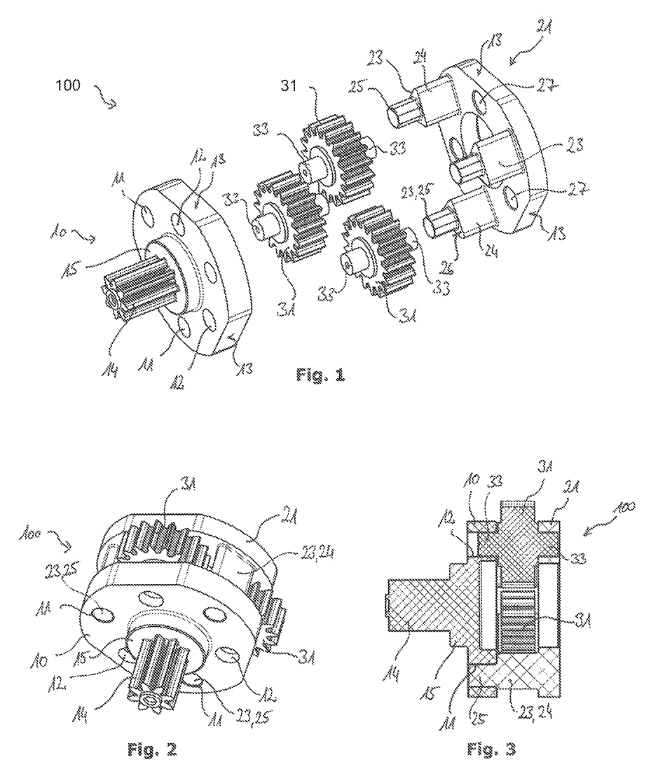

FIGS. 1 to 6 show two different epicyclic gear trains 100, 200, each made from a set according to an exemplary embodiment according to the invention. In general, it is preferably provided that the set according to the invention for the manufacture of the epicyclic gear trains 100, 200, features one or more planet carriers 10. The multiple planet carriers 10 can be identical or different. The two epicyclic gear trains 100, 200 in accordance with FIGS. 1 to 3 and FIGS. 4 to 6, respectively, differ from each other by the planet gears 31, 32 and the respective cover ring 21, 22. The planet carrier 10 features multiple first holes 11 and multiple second holes 12. As a whole, three first holes 11 and three second holes 12 are provided. A different number of holes 11, 12 is possible.

The first holes 11 are arranged on a first circular line around the longitudinal central axis of the planet carrier 10. The second holes are arranged on a second circular line around the longitudinal central axis of the planet carrier 10. The first circular line and the second circular line feature different radii. In other words, the first holes 11 feature a different distance to the longitudinal central axis of the planet carrier 10 than the second holes 12.

The planet carrier 10 is essentially plate-like in design. A drive pinion 14, which is coaxially aligned with the longitudinal central axis of the planet carrier 10, is formed in one piece with the planet carrier 10. The drive pinion 14 extends beyond a base 15, which projects beyond the plate level of the planet carrier 10. The base 15 is also formed in one piece with the planet carrier 10 and the drive pinion 14. The entire planet carrier 10 is preferably formed as a plastic injection-molded part. Alternatively or additionally, the set can feature a planet carrier 10 which, instead of a drive pinion 14, only features a shaft receptacle 17 for accommodating an output shaft 16 (FIG. 8).

The set also comprises multiple first planet gears 31 and multiple second planet gears 32. In specific terms, in the exemplary embodiments shown here in accordance with FIGS. 1 to 3 and FIGS. 4 to 6, three first planet gears 31 and three second planet gears 32 are respectively provided. The first planet gears 31 feature an outer diameter that is larger than the outer diameter of the second planet gears 32. As a whole, the first planet gears 31 feature a higher number of teeth than the second planet gears 32.

Each of the planet gears 31, 32 comprises two bearing pins 33, which project coaxially over the two flanks of the planet gears 31, 32. The bearing pins 33 are preferably formed in one piece with the planet gears 31, 32. In particular, the planet gears 31, 32 with their bearing pins 33 can be formed as plastic injection-molded parts.

The bearing pins 33 of the first planet gears 31 feature a diameter that essentially corresponds to the diameter of the second holes 12 in the planet carrier 10 so that the bearing pins 33 can be inserted into the second holes 12 with a clearance fit. In particular, it is provided in this case that the second holes 12 in the planet carrier 10 feature a smaller diameter than the first holes 11. This ensures that the bearing pins 33 of the first planet gears 31 cannot be inserted into the first holes 11 of the planet carrier 10.

Therefore, the bearing pins 33 of the second planet gears 31 feature a cross-sectional diameter larger than the diameter of the bearing pins 33 of the first planet gears 31. In particular, the bearing pins 33 of the second planet gears 31 preferably feature a cross-sectional diameter that corresponds to the diameter of the first holes 11. Thus, the first holes 11 are larger than the second holes 12.

The set for the manufacture of epicyclic gear trains with different gear reductions also comprises cover rings 21, 22, wherein differently designed cover rings 21, 22 are respectively assigned to the first planet gears 31 or the second planet gears 32. In principle, each of the cover rings 21, 22 features multiple connecting pins 23. The connecting pins 23 extend beyond a plate level of the cover rings 21, 22 and run essentially parallel to a longitudinal central axis of the cover rings 21, 22.

Furthermore, each of the cover rings 21, 22 includes bearing holes 27, which are arranged between the connecting pins 23. Each of the bearing holes 27 and of the connecting pins 23 is arranged in this case on different circular lines of the cover rings 21, 22. The distance between the connecting pins 23 and a longitudinal central axis of the planet carrier 10 is respectively adjusted so that the connecting pins 23 can be connected to either the first holes 11 or the second holes 12 of the planet carrier 10.

The connecting pins 23 have a dual function. On one hand, the connecting pins 23 serve to connect the cover ring 21, 22 with the planet carrier 10. On the other hand, the connecting pins 23 form spacers that define a given distance between the cover ring 21, 22 and the planet carrier 10.

The connecting pins 23 generally feature a body section 24, which essentially assumes the function of a spacer. Starting from body section 24, a head section 25 rises parallelly to the longitudinal central axis of the cover ring 21, 22. The head section 25 features a circumferential dimension that is smaller than a body section 24. This causes a step to be formed between the body section 24 and the head section 25. The step preferably features a surface which extends perpendicularly to the longitudinal central axis of the cover ring 21, 22 and forms a contact surface 26.

The head section 25 serves to connect the cover ring 21, 22 with the planet carrier 10. In order to achieve a firm connection, it is preferred that a press fit is provided between the head section 25 and a hole 11, 12 of the planet carrier 10. It is advantageously provided that the body section 24 is given a polygonal outer circumferential surface. In particular, the body section 24 may feature a hexagonal or octagonal cross-sectional contour. When pressing the head section 25 into one of the holes 11, 12 of the planet carrier 10, the material of the head section 25 can thus flow and thus form a particularly tight press connection with the planet carrier 10.

The contact surface 26 forms a stop, against which the planet carrier 10 rests in the connected state with the cover ring 21, 22. The length of the body section 24 thus defines the distance between the cover ring 21, 22 and the planet carrier 10. This distance guarantees a free rotation of the planet gears 31, 32, which are arranged between the planet carrier 10 and the cover ring 21, 22, or are rotatably mounted in the latter.

The planet gears 31, 32 are mounted in the cover ring 21, 22 by means of bearing holes 27. For this purpose, each of the bearing holes 27 features an inner diameter that essentially features the outer diameter of the bearing pin 33 of the associated planet gear 31, 32, while maintaining a clearance fit.

As can also be clearly seen in FIGS. 1, 2, 4 and 5, the planet carrier 10 and the cover ring 21, 22 respectively feature flattened sides 13. It is preferred in this case if each of the planet carrier 10 and the cover ring 21, 22 feature the same number of flattened sides so that, in the assembled state of the epicyclic gear train, the flattened sides 13 of the planet carrier 10 and of the cover ring 21, 22 are arranged or aligned essentially in the same surface planes. Thus, a suitable assembly device can ensure that a planet carrier 10 is combined with the correct cover ring 21, 22 provided for the specific gear reduction. Three flattened sides 13 are preferably provided on each of the planet carrier 10 and cover ring 21, 22 in order to ensure a clear rotation alignment of the planet carrier 10 and the cover ring 21, 22. The flattened sides 13 thus make it possible to avoid any misalignment between the cover ring 21, 22 and the planet carrier 10.

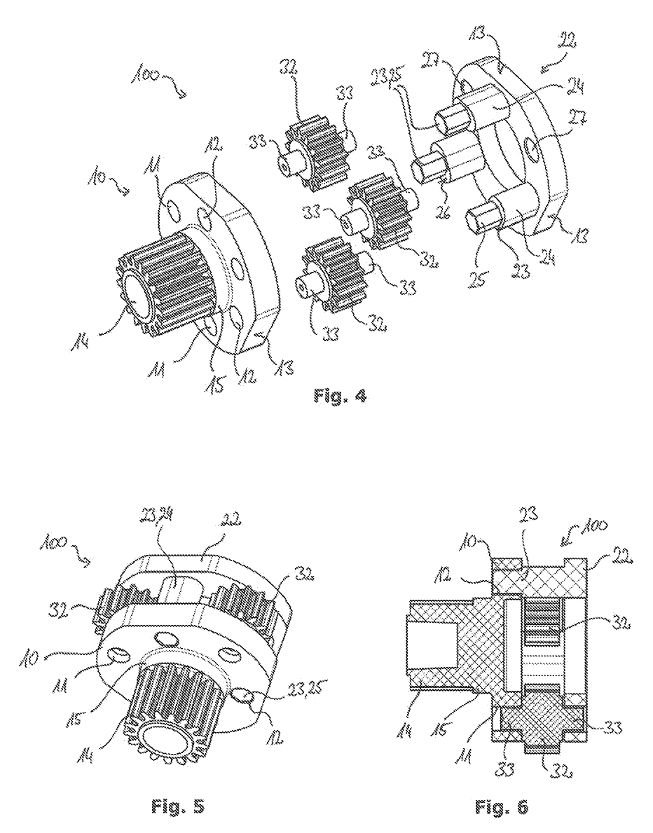

The set for the manufacture of epicyclic gear trains with different gear reduction comprises, in particular, a first cover ring 21 and a second cover ring 22. The first cover ring 21 is used for the manufacture of a first epicyclic gear train 100, which features a first gear reduction. Such an epicyclic gear train is shown in FIGS. 1 to 3. The second cover ring 22 is used for the manufacture of a second epicyclic gear train 200 with a second gear reduction. Such an epicyclic gear train 200 is shown in FIGS. 4 to 6.

The epicyclic gear train in accordance with FIGS. 1 to 3 thus comprises the planet carrier 10 with first holes 11 and second holes 12. The planet carrier 10 is preferably identical for all gear reductions. The first holes 11 serve to accommodate second planet gears 32, which realize a second gear reduction. By contrast, the second holes 12 serve to accommodate first planet gears 31, which realize a first gear reduction.

The first epicyclic gear train 100 in accordance with FIGS. 1 to 3 features multiple second planet gears 32, the bearing pins 33 of which are rotatably mounted in the first holes 11 of the planet carrier 10. In addition, the first planet gears 31 with their opposite bearing pins 33 are rotatably mounted in the bearing holes 27 of a first cover ring 21. The first cover ring 21 features connecting pins 23, which feature a distance to a longitudinal central axis of the first cover ring 21 that corresponds to the distance between the first holes 11 of the planet carrier 10 and the longitudinal central axis of the planet carrier 10. This ensures that the connecting pins 23 of the first cover ring 21 can be inserted into the first holes 11 of the planet carrier 10.

As can be seen in FIG. 1, the connecting pins 23 of the first cover ring 21 feature a body section 24, which features an essentially triangular cross-sectional contour with rounded edges. In this case, the side faces of the triangular cross-section contour are aligned in such a manner that the first planet gears 31 can be freely rotatably inserted between two adjacent connecting pins 23.

The second epicyclic gear train 200 in accordance with FIGS. 4 to 6 also features a planet carrier 10. The planet carrier 10 comprises a base 15 and a drive pinion 14, which are formed in one piece with the planet carrier 10, preferably as a plastic injection-molded part. The diameter of the drive pinion 14 of the second epicyclic gear train 200 differs from that of the drive pinion 14 of the planet carrier 10 of the first epicyclic gear train 100. In principle, the planet carriers 10 can feature different sizes of drive pinions 14 for the formation of epicyclic gear trains 100, 200 with different gear reductions.

Furthermore, in the exemplary embodiment in accordance with FIGS. 4 to 6, the planet carrier 10 also comprises multiple first holes 11 and multiple second holes 12. In specific terms, three first holes 11 and three second holes 12 are provided. The first holes 11 are arranged on a first circular line and the second holes 12 are arranged on a second circular line. The diameters or radii of the circular lines differ. In this respect, the explanations regarding the planet carrier 10 for the first epicyclic gear train 100 apply analogously.

The second epicyclic gear train 200 is formed by another combination of individual components of the set according to the invention. In particular, the second epicyclic gear train 200 comprises multiple second planet gears 32, each of which is rotatably mounted in the first holes 11 of the planet carrier 10. To this end, each of the second planet gears 32 features bearing pins 33, the outer diameter of which is adapted to the inner diameter of the first holes 11 of the planet carrier 10. In this case, a clearance fit is provided so that the second planet gears 32 can be rotatably mounted in the first holes 11.

In addition, a second cover ring 22 is provided for the manufacture of the second epicyclic gear train 200, which cover ring 22 features multiple, in particular three, connecting pins 23. The connecting pins 23 feature a body section 24 and a head section 25. The head section 25 features an essentially hexagonal cross-section geometry.

The head section 25 is dimensioned in such a manner that it can be press-connected to the second holes 12 of the planet carrier 10. The body section 24 features a circumferential dimension that is larger than the circumferential dimension of the head section 25, such that a contact surface 26 is formed at one end of the body section 24, from which the head section 25 continues. The contact surface 26 preferably extends perpendicularly to a longitudinal central axis of the second cover ring 22.

With the second epicyclic gear train 200, it is provided that the body section 24 features an essentially oval cross-sectional shape. The distance between two adjacent connecting pins 23 is dimensioned in such a manner that the first planet gears 31 for forming the first epicyclic gear train 100 cannot be inserted between the two connecting pins 23 of the second cover ring 22. This further prevents the accidental combination of the first planet gears 31 with the second cover ring 22.

The second cover ring 22 features bearing holes 27 respectively arranged between two connecting pins 23. The bearing holes 27 feature an inner diameter which is dimensioned in such a manner that the bearing pins 33 of the second planet gears 32 can be inserted into the bearing holes 27 with clearance and in a rotatably mounted manner.

In the second epicyclic gear train 200, it is likewise provided that the planet carrier 10 and the second cover ring 22 feature flattened sides 13. In particular, three flattened sides 13 are provided. As is the case with the first epicyclic gear train 100, the flattened sides 13 are used for a specific alignment of the planet carrier 10 and the second cover ring 22 in relation to each other to avoid incorrect assembly.

FIGS. 7 to 10 show an additional variant of a set for the manufacture of epicyclic gear trains 100, 200. Essentially, the set also comprises planet carriers 10, planet gears 31, 32 and cover rings 21, 22, which can be combined with each other to form different gear reductions. In contrast to the exemplary embodiments in accordance with FIGS. 1 to 6, the planet carrier 10 in the exemplary embodiments in accordance with FIGS. 7 to 10 does not feature a drive pinion 14 formed in one piece with the planet carrier 10. Instead, an output shaft 16 is provided, which is pressed into the planet carrier 10, in particular a shaft receptacle 17 formed in the base 15. The output shaft 16 features a feather key groove 18.

It can also be seen from FIGS. 7 and 9 that the first holes 11 and the second holes 12 are arranged on circular lines that feature different radii. In particular, the second holes 12 feature a smaller distance to the longitudinal central axis of the planet carrier than the first holes

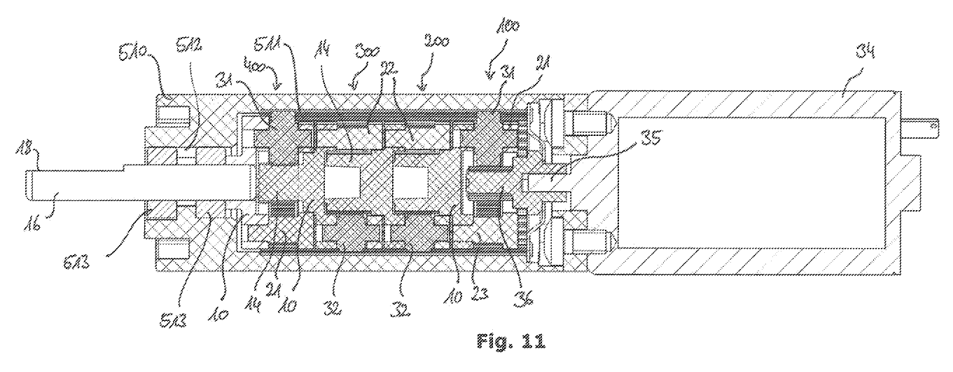

FIG. 11 shows a longitudinal view through a motor gear combination, wherein the motor is only schematically indicated as motor housing 34. A motor shaft 35 is indicated as part of the motor housing 34.

The motor gear combination also comprises a transmission 500, which comprises a transmission housing 510. The transmission housing 510 forms an internally toothed ring gear 511 in one piece. On the output side, the transmission housing comprises a rolling bearing retainer 512, in which one or more, preferably two, rolling bearings 510 are arranged. An output shaft 16 of a planet carrier 10 is rotatably mounted in the rolling bearings 513.

The transmission 500 according to the exemplary embodiment in accordance with FIG. 11 features a total of four epicyclic gear trains. The individual epicyclic gear trains of the transmission 500 in accordance with FIG. 11 are hereinafter referred to, in the direction of power flow from the motor shaft 35 to the output shaft 16, as the first epicyclic gear train 100, the second epicyclic gear train 200, the third epicyclic gear train 300 and the fourth epicyclic gear train 400.

In specific terms, the motor shaft 35 is initially connected to a sun gear 36 in a torque-proof manner. The sun gear 36 meshes with the first planet gears 31 of the first epicyclic gear train 100. The first planet gears 31 also mesh with the ring gear 511 of the transmission housing 510.

On the one hand, the first planet gears 31 are mounted with their bearing pins 33 in bearing holes 27 of a first cover ring 21. On the other hand, the first planet gears 31 are mounted with their further bearing pins 33 in the second holes 11 of a planet carrier 10. The planet carrier 10 of the first epicyclic gear train 100 is essentially formed according to the planet carrier 10 in FIG. 4. In specific terms, the planet carrier 10 features a drive pinion 14, which acts as a sun gear for a subsequent second epicyclic gear train 200.

In the transmission 500 in accordance with FIG. 11, the second epicyclic gear train 200 is equipped with second planet gears 32, which mesh with the drive pinion 14 of the first epicyclic gear train 100. In addition, the second planet gears 32 engage in the internal toothing of the ring gear 511.

The second planet gears 32 of the second epicyclic gear train 200 are mounted with their bearing pins 33 in bearing holes 27 of a second cover ring 22 on the one side and in the first holes 11 of a planet carrier 10 on the other side. The planet carrier 10 of the second epicyclic gear train 200 is essentially identical to the planet carrier 10 of the first epicyclic gear train 100. In specific terms, the planet carrier 10 features a drive pinion 14, in particular in a manner analogous to the planet carrier 10 in accordance with FIG. 4.

The drive pinion 14 of the second epicyclic gear train 200 serves as a sun gear for a third epicyclic gear train 300. The third epicyclic gear train 300 in turn comprises multiple second planet gears 32, which mesh with the drive pinion 14 of the second epicyclic gear train 200. The second planet gears 32 of the third epicyclic gear train also mesh with the internally toothed ring gear 511.

The third epicyclic gear train 300 in turn comprises a second cover ring 22 with bearing holes 27. In the bearing holes 27, the second planet gears 32 of the third epicyclic gear train 300 are rotatably mounted with their bearing pins 33. Opposite bearing pins 33 of the planet gears 32 of the third epicyclic gear train 300 are rotatably mounted in first holes 11 of an additional planet carrier 10.

The planet carrier 10 of the third epicyclic gear train 300 is essentially formed according to the planet carrier 10 in accordance with FIG. 1. Thus, the planet carrier 10 of the third epicyclic gear train 300 also comprises a drive pinion 14. However, the drive pinion 14 of the third epicyclic gear train 300 features an outer diameter that is smaller than the outer diameter of the drive pinion 14 of the first and second epicyclic gear trains 100, 200.

The drive pinion 14 of the third epicyclic gear train 300 serves as a sun gear for a fourth epicyclic gear train 400. The fourth epicyclic gear train 400 features first planet gears 31 in a manner analogous to the first epicyclic gear train 100. Each of the first planet gears 31 meshes with the drive pinion 14 of the third epicyclic gear train 300 and the internally toothed ring gear 511 of the transmission housing 510. Each of the first planet gears 31 of the fourth epicyclic gear train 400 comprises opposite bearing pins 33, with which the first planet gears 31 are mounted in bearing holes 27 of the first cover ring 21 and in second holes 12 of the planet carrier 10 of the fourth epicyclic gear train 400.

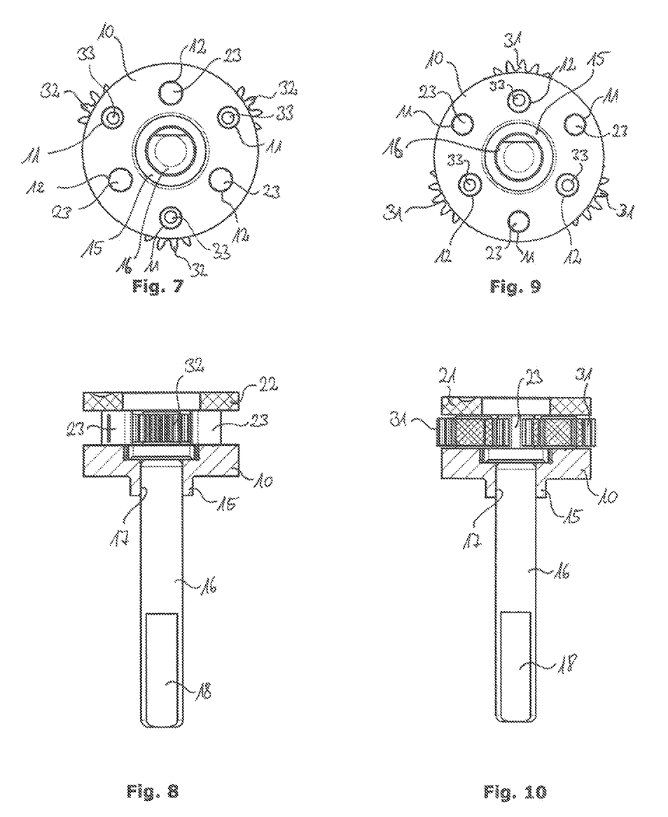

The planet carrier 10 of the fourth epicyclic gear train 400 is essentially formed as shown in the exemplary embodiment in accordance with FIG. 10. Thus, the planet carrier 10 of the fourth epicyclic gear train 400 features a shaft receptacle 17 into which the output shaft 16 is pressed. The output shaft 16 extends through the rolling bearing retainer 512 and is mounted in the rolling bearings 513.

As can be clearly seen in FIG. 11, the set for the manufacture of epicyclic gear trains in accordance with the invention is well suited for the manufacture of multi-stage transmissions, wherein different gear reductions can be achieved quickly and easily by means of the standardized components and the reliable-mounting design. In the manner of a modular system, different planet carriers 10, cover rings 21, 22 and planet gears 31, 32 can thus be combined with each other, wherein a variety of different gear reductions can be provided. Transmissions with different transmission stages can also be manufactured with a comparatively small number of standardized components.

By using cover rings 21, 22 for the formation of epicyclic gear trains, the planet gears 31, 32 are mounted on both sides, which reduces bending loads on the bearing pins 33. This results in even gear running and high fatigue strength.

As a general rule, the head section 25 of the connecting pin 23 is preferably designed as a polygon, for example as a hexagon or octagon. This achieves a tolerance compensation for pressing the connecting pin 23 into the first or second hole 11, 12 of the planet carrier 10. Instead of pressing the connecting pins 23 into the holes 11, 12 of the planet carrier 10, it is also possible to realize a connection by hot caulking or welding. In order to ensure a higher torque capacity, it can be provided to manufacture the planet carrier 10 or individual variants of the planet carrier 10 within the set from metal.

Preferably, the bearing pins 33 of the second planet gears 32 feature a diameter that is larger than the diameter of the bearing pins 33 of the first planet gears 31. At the same time, the first planet gears 31 feature an outer diameter that is larger than the outer diameter of the second planet gears 32. Thus, the first planet gears 31 form larger planet gears with a smaller bearing pin diameter, and the second planet gears 32 form smaller planet gears with a larger bearing pin diameter.

A first cover ring 21 is assigned to the larger planet gears or the first planet gears 31. A second cover ring 22 is assigned to the smaller or second planet gears 32. In this case, the second cover ring 22 features connecting pins 23, the distance relative to each other of which is dimensioned in such a manner that the second or smaller planet gears 32 can indeed be arranged in between. However, the distance between the connecting pins 23 of the second cover ring 22 is so small that the first or larger planet gears 31 do not fit between these connecting pins 23. This prevents the second cover ring 22, which is provided for the second planet gears 32, from being combined with the first planet gears 31. In other words, an incorrect assembly of the large planet gears is prevented.

The connecting pins 23 of the second cover ring 22 are also adapted such that they can only be connected to second holes 12 of the planet carrier 10. By contrast, the connecting pins 23 of the first cover ring 21 can only be connected to first holes 11 of the planet carrier 10. In a combination of a planet carrier 10 with a cover ring 21, 22, the connecting pins 23 of the cover ring 21, 22 thus occupy the holes 11, 12, which are not to be used to accommodate suitable planet gears 31, 32.

The second cover ring 22, which prevents the assembly of the first planet gears 31 as a result of the distances between the connecting pins 23, features connecting pins 23 which only fit into the second holes 12 of the planet carrier 10. The second or smaller planet gears 32 feature bearing pins 23 whose diameter is larger than the diameter of the second holes 12 in the planet carrier 10. Thus, the second planet gears 32 can only be mounted in the first holes 11 of the planet carrier 10. As a result of the cross-sectional diameter of the bearing pin 33 of the respective second planet gear 32, which is only compatible with the larger, first holes 11 of the planet carrier 10, an incorrect assembly of the second planet gears 32 is thus avoided.

The one-piece design of bearing pins 33 and planet gears 31, 32 has the particular advantage that the planet gears 31, 32 can be injection-molded in this manner via a central injection point. This results in a higher quality of the toothing of the planet gears 31, 32, as the injection mold is injected symmetrically. This reduces the risk of the formation of a weld line. In addition, in comparison to injection-molded planet gears 31, 32, which feature through-holes, the shape tolerance is improved in this way. As a result of the symmetrical injection of the injection mold, an improvement of the tooth root strength of the planet gears 31, 32 can also expected.

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

### LIST OF REFERENCE SYMBOLS

10 Planet carrier
11 First hole
12 Second hole
13 Flattened side
14 Drive pinion
15 Base
16 Output shaft
17 Shaft receptacle
18 Feather key groove
21 First cover ring
22 Second cover ring
23 Connecting pins
24 Body section
25 Head section
26 Contact surface
27 Bearing hole
31 First planet gear
32 Second planet gear
33 Bearing pin
34 Motor housing
35 Motor shaft
36 Sun gear
100 First epicyclic gear train
200 Second epicyclic gear train
300 Third epicyclic gear train
400 Fourth epicyclic gear train
500 Transmission
510 Transmission housing
511 Ring gear
512 Rolling bearing retainer
513 Rolling bearings

What is claimed is:

1. A set for the manufacture of epicyclic gear trains with different gear reductions, the set comprising:
a. at least one planet carrier, which features
at least two first holes arranged on a first circular line, and
at least two second holes arranged on a second circular line,
wherein the first circular line and the second circular line have different radii;
b. at least one first cover ring for a first gear reduction and at least one second cover ring for a second gear reduction, each cover ring of which has at least two bearing holes for receiving bearing pins of planet gears, wherein
the first cover ring includes at least two connecting pins for connecting to the first holes of the planet carrier, and
the second cover ring includes at least two connecting pins for connecting to the second holes of the planet carrier; and
c. at least two first planet gears for a first gear reduction and at least two second planet gears for a second gear reduction, wherein each of the first planet gears and each of the second planet gears has two bearing pins, which can be mounted in the first or second holes of the planet carrier on the one side and the bearing holes of the first or second cover ring on the other side.

2. The set according to claim 1, wherein the first holes of the planet carrier feature a different diameter than the second holes of the planet carrier.

3. The set according to claim 1, wherein the bearing pins of the first planet gears have a diameter that corresponds to the diameter of the second holes of the planet carrier, and/or the bearing pins of the second planet gears have a diameter that corresponds to the diameter of the first holes of the planet carrier.

4. The set according to claim 1, wherein the first planet gears have a larger outer diameter made up of a larger number of teeth, than the second planet gears.

5. The set according claim 1, wherein the bearing pins of the first planet gears have a smaller outer diameter than the bearing pins of the second planet gears.

6. The set according to claim 1, wherein each of the connecting pins of the second cover ring feature a distance to each other that is smaller than a diameter of the first planet gears.

7. The set according to claim 1, wherein the connecting pins of the first cover ring are arranged on a circular line whose diameter corresponds to the diameter of the first circular line of the planet carrier.

8. The set according to claim 1, wherein the connecting pins of the second cover ring are arranged on a circular line whose diameter corresponds to the diameter of the second circular line of the planet carrier.

9. The set according to claim 1, wherein each of the connecting pins has a body section and a head section, wherein the head section features smaller circumferential dimensions than the body section.

10. The set according to claim 9, wherein the body section has a contact surface for the planet carrier, which contact surface is arranged at least in sections perpendicularly to a longitudinal axis of the connecting pin.

11. The set according to claim 9, wherein the body section features at least one outer dimension that is larger than the diameter of the first or second holes of the planet carrier.

12. The set according to claim 9, wherein the head section can be press-connected to the first or second holes of the planet carrier.

13. The set according to claim 9, wherein the head section features a polygonal cross-sectional shape.

14. The set according to claim 1, wherein the planet carrier has a circumference and has at least one flattened side on the circumference.

15. The set according to claim 14, wherein each of the first cover rings and each of the second cover rings have flattened sides that, in the assembled state, are aligned with the flattened sides of the planet carrier.

16. The set according to claim 1, wherein the planet carrier is formed from a metal and/or from a plastic.

17. The set according to claim 1, wherein the cover ring is formed from a plastic.

18. A gear assembly formed from a set in accordance with claim 1, wherein the gear assembly features a planet carrier, a first cover ring or a second cover ring and at least two first planet gears or at least two second planet gears.
